(19) United States
(12) Patent Application Publication
(10) Pub. No.: US 2026/0295847 A1
(43) Pub. Date: Oct. 1, 2026

(54) STATION FOR MOVING OBJECTS USING MACHINE LEARNING MODELS

(71) Applicant: Amazon Technologies, Inc., Seattle, WA (US)

(72) Inventors: Timothy Stallman, Groton, MA (US); Jeremy Kenneth Skorinko, Sterling, MA (US); Spencer Pallas, Berlin, MA (US)

(21) Appl. No.: 19/093,127

(22) Filed: Mar. 27, 2025

(51) Int. Cl. B25J 9/16; B25J 9/00; B65G 47/91; G05B 13/02; G06V 10/75; G06V 10/82; G06V 20/60

(52) U.S. Cl. CPC B25J 9/1697; B25J 9/0093; B25J 9/163; B65G 47/917; G05B 13/027; G06V 10/759; G06V 20/60; B65G 2203/0216; G06V 10/82

(57) ABSTRACT

Systems and methods are disclosed for a station used to move and capture objects from one area to another. The systems may obtain a first set of images that includes an object located within a region positioned corresponding to the first area, wherein the region is to be determined based, at least in part, on a field of view of a first sensor that generated the first set of images. The systems may identify, using a first machine learning model, an identifier associated with the object based, at least in part, on the first set of images. The systems may generate using a second machine learning model, an indication of whether the object is placed inside the first container based, at least in part, on the second set of images.

### BACKGROUND

Computer systems in fulfillment and distribution centers may rely on barcode scanners to identify items using barcodes or other identifiers. However, these scanners may require precise alignment and manual adjustments of the items to capture identifiers accurately. Because the computer systems may depend on scanner input for tracking and processing items, any scanning inefficiencies, such as failed reads due to item orientation, obstructions, or lighting conditions, result in processing delays and increased operational costs. This reliance on manual scanning introduces bottlenecks, limiting automation and reducing overall system efficiency.

### BRIEF DESCRIPTION OF THE DRAWINGS

Various techniques will be described with reference to the drawings, in which:

FIG. 1 illustrates a system to move an object using machine learning models, according to at least one embodiment;

FIG. 2 illustrates system to use machine learning models to generate status information of objects to move objects, according to at least one embodiment;

FIG. 3 illustrates a system to train and deploy machine learning models, according to at least one embodiment;

FIG. 4 illustrates a station to move an object using machine learning models, according to at least one embodiment;

FIG. 5 illustrates a process performed by at least one processor to move an object using machine learning models, according to at least one embodiment;

FIG. 6 illustrates a process performed by at least one processor to determine whether an object complies with a checklist using machine learning models, according to at least one embodiment;

FIG. 7 illustrates a process performed by at least one processor to determine whether an object matches those previously captured in other parts of the environment, according to at least one embodiment; and

FIG. 8 illustrates a system in which various embodiments can be implemented.

### DETAILED DESCRIPTION

Systems and methods are described herein for the identification, examination, and placement of objects using computer vision and artificial intelligence (e.g., machine learning models/algorithms, deep learning, neural networks). Within stations (e.g., station) at a fulfillment center, using off-the-shelf scanners to identify objects (e.g., items) may be inefficient and can cause delays and use excessive computing resources in computer systems processing information associated with the objects and controlling the machinery that moves them.

The systems may include a station of a fulfillment center where items can be picked from a retrieval floor and conveyed to the station. The station may include sensors (e.g., cameras) that allows operators (e.g., associates, robots) to pass items through an area of interest without needing to perform individual scans. As a result, the systems can optimize the process flow within a fulfillment center by eliminating the need for discrete scanning and manual inspection of each object.

Specifically, the structure of the station can be ergonomically configured to enhance efficiency and minimize operator (e.g., human, robot) movement. The station may include a first rectangular area that intersects with other areas, such as a third rectangular area and a second rectangular area. In some examples, the third rectangular area can be positioned to the left of the first rectangular area, while the second rectangular area is located below it, forming an L-shape or T-shape, depending on the perspective from which the station is viewed. In other examples, a first edge, shared by the first rectangular area and the third rectangular area, can be perpendicular to a second edge shared by the first rectangular area and the second rectangular area. This can allow the operator to perform operations (e.g., pick, scan, place) on items in different areas without needing to move around the station. Additionally, this can also allow the operators to stand at a 45 degree angle, reducing body torsion and enabling them to move items from a container (e.g., tote) to another container (e.g., tray) seamlessly. The placement of components of the station such as various containers, conveyor belt, and sensors further described herein can be optimized for short travel distances, further enhancing efficiency.

The systems may use a first machine learning model, such as convolutional neural networks (CNN) or transformer neural networks, to identify the locations of the identifiers (e.g., two-dimensional (2D) barcodes, three-dimensional (3D) barcodes) and decode them. The first machine learning model may processes images captured by the camera to automatically identify and scan items as they pass through an area of interest situated above the first rectangular area. The first machine learning model may predict the item being manipulated to enter the area of interest and generate a binary mask for it. This binary mask can then be used by other parts of the first machine learning model to identify the identifiers within the item. For example, the binary mask can be applied to the pixels corresponding to the manipulated object, or conversely, to the pixels that do not correspond to the manipulated object This area of interest can be configured using the sensors' fields of view, which may vary based on the sensors' location, position, and angle, as well as the L or T-shaped setup, the dimensions (e.g., length, width, height, angle) of the distinct rectangular areas within the station, and the coordinates of the containers (e.g., tote, tray). In some cases, the area of interest can be a 3D polygon, serving as the scanning plane. This setup can allow the first machine learning model to identify the barcode's location (e.g., coordinates) and decode any barcode within this area without requiring additional movement or effort from the operator. The input to the first machine learning model may include images captured by the sensors, and its output can be the identification of the scanned item. The first machine learning model can include a barcode decoder to generate information about the scanned item.

The systems may use a second machine learning model to classify the state of the tray, determining whether it is empty or contains an object. The input for the second machine learning model may include a single image captured by one of the sensors, to determine the tray's status within, for example, 30 milliseconds. The number of images used for the second machine learning model may depend on the target time frame for determining the status. In some cases, the second machine learning model may use multiple images to improve prediction accuracy. The same sensors that provide inputs for the first machine learning model can also supply inputs for the second machine learning model. In other examples, sensors positioned in different locations, such as above the third rectangular area, can capture images for the second model. The second machine learning model may use classification techniques to differentiate between two distinct states: an empty tray and a tray with an item. If the model's confidence in its classification is low, it may use a signaling device (e.g., light curtain) as a secondary verification method. For instance, the beams from the light curtain can determine whether an arm manipulating the item has entered the third rectangular area and also ensure that the arm left the third rectangular area after placing the item, allowing the tray to proceed (e.g., move from the tote station to its destination).

The systems may use a third machine learning model to inspect items further and detect anomalies, such as leaks. This third machine learning model causes the systems to route items to the appropriate station based on the analysis. Specifically, after identifying issues through a checklist that comprises different criteria and/or factors, the systems may determine the item's destination. For instance, a leaking shampoo bottle can be redirected to a station within the fulfillment center that handles damaged items. Similarly, an item exceeding a size threshold can be sent to stations designated for oversized items. The third machine learning model assesses whether an object meets the checklist of common inspection criteria and/or uses a lookup table to determine the appropriate routing for each object. The third machine learning model evaluates each item against a checklist comprising one or more binary conditions (e.g., yes/no, pass/fail, state1/state2) to determine whether the item is valid for continued processing or invalid and requires repair, review, or remediation. Additionally, it performs one-to-one image comparisons to ensure items match their stored images, eliminating the need for identifier recognition performed by the first machine learning model. The third machine learning model can use images captured from various stages of the induct or manipulation process. In some examples, the systems may train or use a fourth machine learning model that comprises a combination of the first machine learning model, second machine learning model, and third machine learning to perform multiple tasks (e.g., identifying barcodes, determining whether the items are placed, determining whether the item complied with the checklist).

Consequently, the systems can enable entities to pick items from the second rectangular station and move them to the third rectangular station, while the items are automatically scanned as they pass through the first rectangular station. systems allow entities to scan items without the need for further manipulation (e.g., rotating them to reveal identifiers). The systems may help minimize the need for lifting items and moving around different parts of the station. The entities can turn up to 90 degrees and optimize the path to streamline the entire induct process. In some examples, when the entities are robotic arms, such as end-of-arm tools (EoAT), the systems can coordinate these robotic arms with the machine learning models to minimize movement, thereby reducing delays and the computational power required for operation.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure including using machine learning models (e.g., neural networks) to identify objects that are to be moved within a station, certain embodiments may be capable of achieving certain advantages, including some or all of the following: (1) reducing the need for manual barcode scanning by automatically identifying barcodes with high accuracy, even in challenging conditions such as poor lighting or occlusions; (2) enhancing system adaptability by allowing continuous learning and adaptation to new barcode patterns over time, thus eliminating the need for manual updates or interventions; (3) increasing processing speed and efficiency by enabling real-time barcode data processing, which provides immediate feedback and decision-making without manual input; and (4) facilitating seamless integration with other digital systems and technologies, thereby automating workflows and reducing reliance on manual barcode scanning processes, etc.

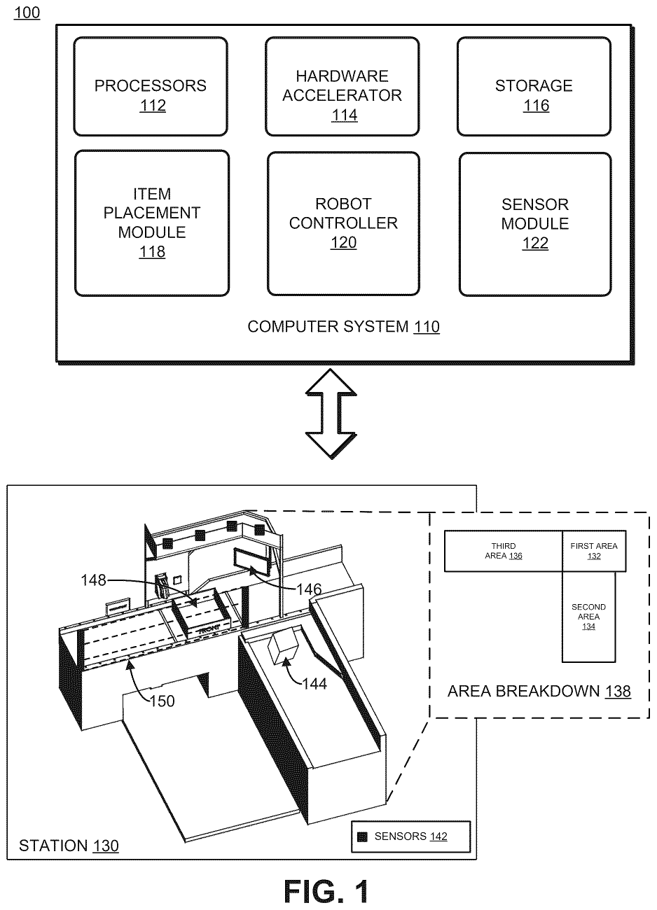

FIG. 1 illustrates system 100 to move an object using machine learning models, according to at least one embodiment. System 100 may include station 130, which may serve as a station of a fulfillment center for receiving various items (e.g., object 144) stored in one or more containers (e.g., totes). station 130 may scan the items and places them into a separate container for packaging to fulfill one or more orders. station 130 may include three distinct areas, as indicated by area breakdown 138 of station 130: first area 132, second area 134, and third area 136. First area 132 can be a rectangular space where display 146 and some of sensors 142 are positioned above. An area of interest, designated for scanning items like object 144, can be positioned above the first area 132. The area of interest can be physically marked within station 130 or can be virtual. Further details about this area of interest are provided herein.

Additionally, second area 134 can be a rectangular space designed to receive containers, such as totes, that hold the items. Third area 136 can be a rectangular space that includes second container 148 for placing the items and uses light curtain system 150 to indicate whether the items are stored within the second container 148. Light curtain system 150 may refer to a sensing device comprising of an array of infrared beams along one edge of third area 136, used to detect the movement of an entity (e.g., a robot) or to trigger a response when the beams are interrupted. can cover the bottom edge of third area 136 or a specific portion of the bottom edge adjacent to second container 148. In some examples, light curtain system 150 may include an emitter (e.g., a set of LEDs) arranged in a row to emit parallel light beams (e.g., infrared or visible light), a receiver (e.g., a set of photodetectors) aligned with the emitter to detect these light beams, and a controller to process signals from the receiver and communicate with the item placement module 118. The beams can form a cross-hatched pattern. The emitter and receiver can be positioned opposite each other at a fixed distance. The light curtain system 150 may perform pulse modulation to differentiate its own beams from ambient light interference. When various entities (e.g., associates, operators, robotic arms) enter light curtain system 150, they block one or more beams. The receiver detects which beams are interrupted and sends a signal to the controller. In some examples, other signaling devices such as laser scanners, photoelectric sensors, ultrasonic sensors, infrared sensors, radar sensors, and Radio Frequency Identification (RFID) systems may be used. In other examples, vision systems, which combine cameras and machine learning models, may generate indications of whether a robotic arm or an associate has passed through an area, or a barrier configured by the vision system.

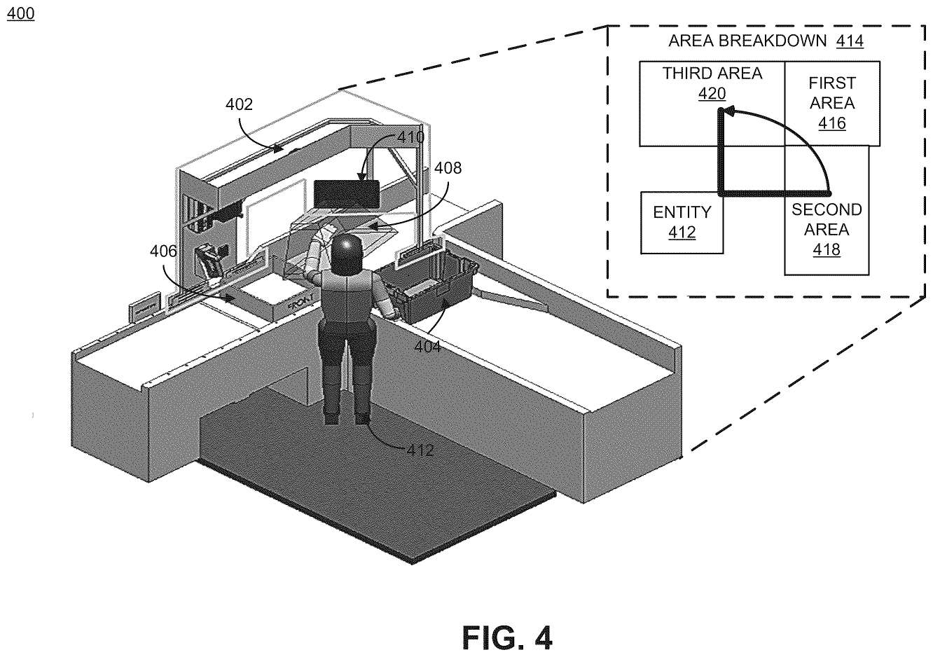

In at least one embodiment, some of the sensors 142 can be positioned above the third area 136, and a hood is placed to cover portions of both the third area 136 and the first area 132. Specifically, the sensors 142 are positioned beneath the hood. First area 132 may serve as the intersection between third area 136 and second area 134, forming an L-shape where third area 136 and second area 134 are perpendicular to each other. The L-shape design may allow entities operating at the station 130 to move items efficiently while minimizing their movement. In one example, entities such as associates or operators can just rotate their torso up to 45 degrees and their arms up to 90 degrees to pick an item at second area 134, move the item to first area 132 for automatic scanning, and placing the item within second container 148 within third area 136. In other examples, robotic arms (e.g., EoAT) can just rotate turn a few degrees (e.g., 45 degrees) given this L-shape design. Furthermore, third area 136 and first area 132 may include a container belt to move second container 148. Second container 148 can be placed on the container belt to be inside the station 130 (e.g., enter station 130) for storing items like object 144, and then move outside the station 130 (e.g., exit station 130) for further processing (e.g., move to another station or robots) within the fulfillment center. In some examples, at least one of first area 132, second area 134, or third area 136 can take various shapes, including but not limited to circular, hexagonal, rectangular, irregular, or any other geometric, polymorphic, or freeform configurations. Additional details of station 130 is described in conjunction with FIG. 4.

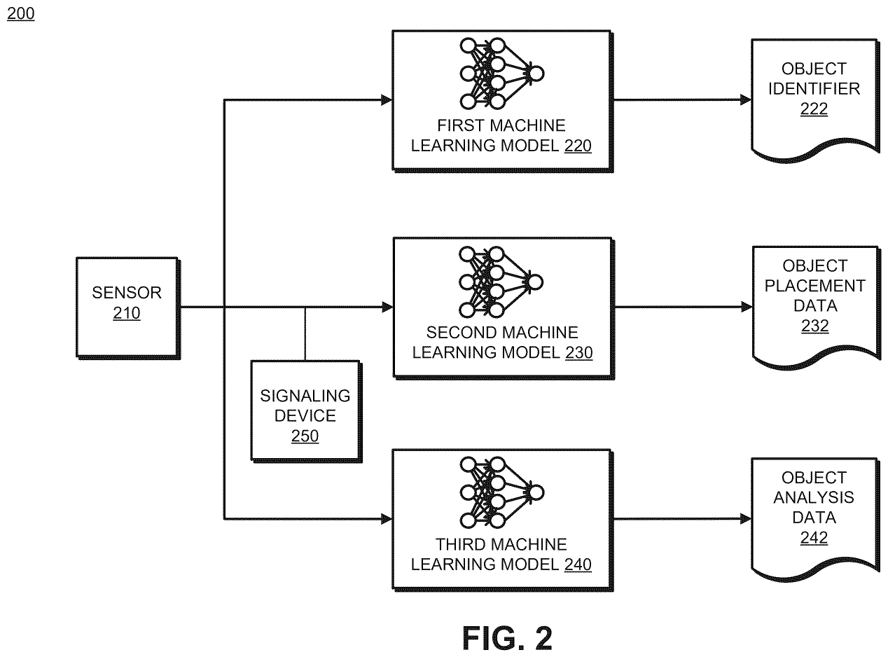

An example operation performed within station 130 includes receiving object 144 in second area 134. Entities such as associates, operators, or robots can pick up object 144 and place it into second container 148 (e.g., a tray). The path from second area 134 to third area 136 may pass through first area 132. As object 144 moves through the first area 132, item placement module 118 of computer system 110 may coordinate with sensor module 122 to capture a set of images. These images may serve as inputs for a set of machine learning models (e.g., the first machine learning model 220 shown in FIG. 2) to identify one or more identifiers of object 144 and extract information from them. This process eliminates the need for discrete scanning, such as using a conventional barcode reader.

Additionally, after scanning object 144, item placement module 118 works with sensor module 122 of computer system 110 to capture a second set of images. The second set of images can be used as inputs for a second set of machine learning model (e.g., the second machine learning model 220 shown in FIG. 2) to verify whether the entities have placed object 144 into the second container 148. In some cases, the item placement module 118 collaborates with the sensor module 122 to use a third set of machine learning model (e.g., the third machine learning model 240 illustrated in FIG. 2) to apply various criteria for examining object 144. The results of this examination can help determine the destination of the second container 148, which is located outside the station 130 but within the fulfillment center. The third set of machine learning models can also perform additional tasks, such as comparing previously captured images of different objects, potentially including object 144, allowing the computer system 110 to gather information about object 144 generated from other stations within the fulfillment center without needing to identify the location of the identifiers (e.g., coordinates).

In at least one embodiment, computer system 110 may include one or more processors 112, one or more hardware accelerators 114, storage 116, item placement module 118, robot controller 120, and sensor module 122. In at least one embodiment, computer system 110 can be an edge device physically integrated with station 130 to execute various functionalities (e.g., computer vision, artificial intelligence) as described herein. In some examples, computer system 110 may be cloud-based and connected through various types of network communication (e.g., wireless, wired, or cellular). Components of computer system 110 may be physically integrated with a station that may refer to a designated area where employees or automated systems equipped with robots receive containers (e.g., totes) including objects that are to be distributed while other components may be cloud-based and connected via network communication.

In at least one embodiment, one or more processors 112 may refer to one or more central processing units (CPU) or any other general-purpose processors. Computer system 110 may use one or more processors 112 with one or more hardware accelerators 114 to execute modules such as item placement module 118, robot controller 120, and sensor module 122. As used in any implementation described herein, unless otherwise clear from context or stated explicitly to the contrary, terms such as “module” and nominalized verbs (e.g., item placement module 118, robot controller 120, and sensor module 122) illustrated in at least FIG. 1 each refer to any combination of software and/or hardware configured to provide specific functionality.

In at least one embodiment, terms such as “software” described herein may include one or more of the following: operating systems, device drivers, application software, database software, graphics software, web browsers, development software (e.g., integrated development environments, code editors, compilers, interpreters), network software, simulation software, real-time operating systems (RTOS), artificial intelligence software, robotics software, firmware (e.g., BIOS/UEFI, router, smartphone, consumer electronics, embedded systems, printer, solid state drive (SSD)), APIs, containerized software, container orchestration platforms, algorithms, instructions, and any other implementation embedded as a software package, code, and/or instruction set.

In at least one embodiment, terms such as “hardware” described herein may include one or more components one or more processors 112, one or more hardware accelerators 114, and one or more sensors 142. The “hardware” may further include hardwired circuitry, programmable circuitry, state machine circuitry, fixed function circuitry, execution unit circuitry, and/or firmware that stores instructions executed by programmable circuitry.

In at least one embodiment, one or more hardware accelerators 114 may refer to one or more of specialized hardware units designed to perform specific tasks more efficiently than a general-purpose processor. The one or more hardware accelerators 114 may include one or more of integrated circuit (IC), system on-chip (SoC), graphics processing unit (GPU), data processing unit (DPU), digital signal processor (DSP), tensor processing unit (TPU), accelerated processing unit (APU), application-specific integrated circuits (ASIC), intelligent processing unit (IPU), neural processing unit (NPU), smart network interface controller (SmartNIC), vision processing unit (VPU), field-programmable gate array (FPGA), etc.

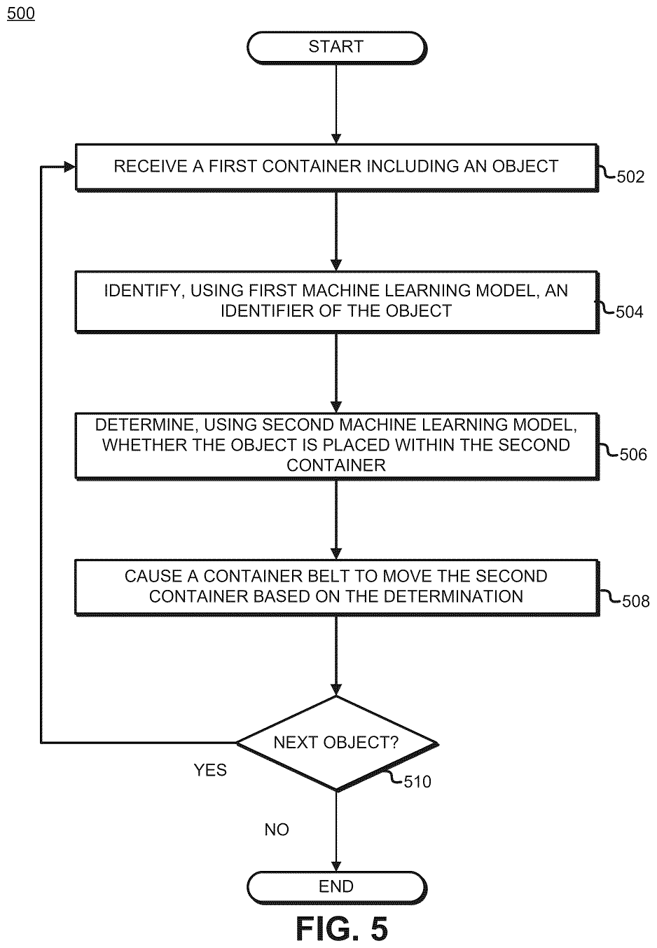

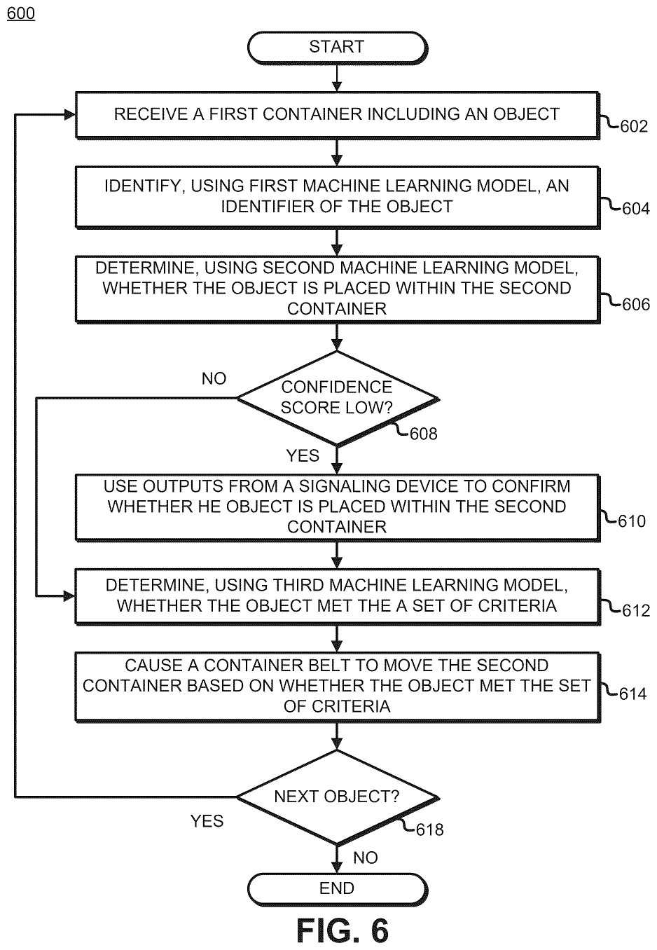

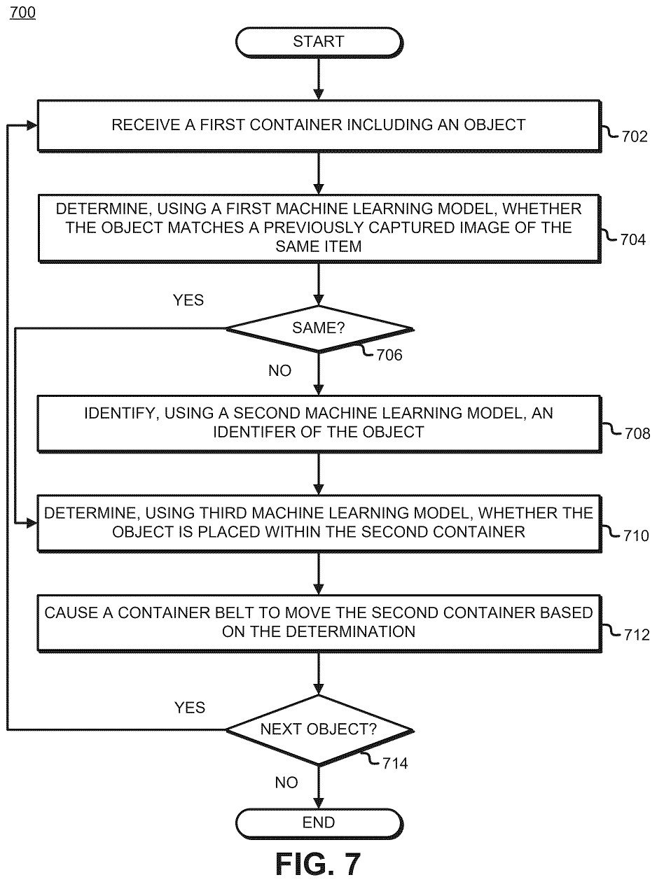

The specific tasks performed by one or more hardware accelerators 114 may include machine learning model inferencing and training described in conjunction with FIGS. 1, 2 and 4. item placement module 118 and/or sensor module 122 use one or more hardware accelerators 114 for these tasks. For example, machine learning model inferencing for the tasks may include image classification, object detection, image segmentation (e.g., semantic segmentation, instance segmentation), image super-resolution, image synthesis and generation, style transfer). Additionally, one or more hardware accelerators 114 may accelerate the performance of one or more blocks of process 500 illustrated in FIG. 5, process 600 illustrated in FIG. 6 and/or process 700 illustrated in FIG. 7.

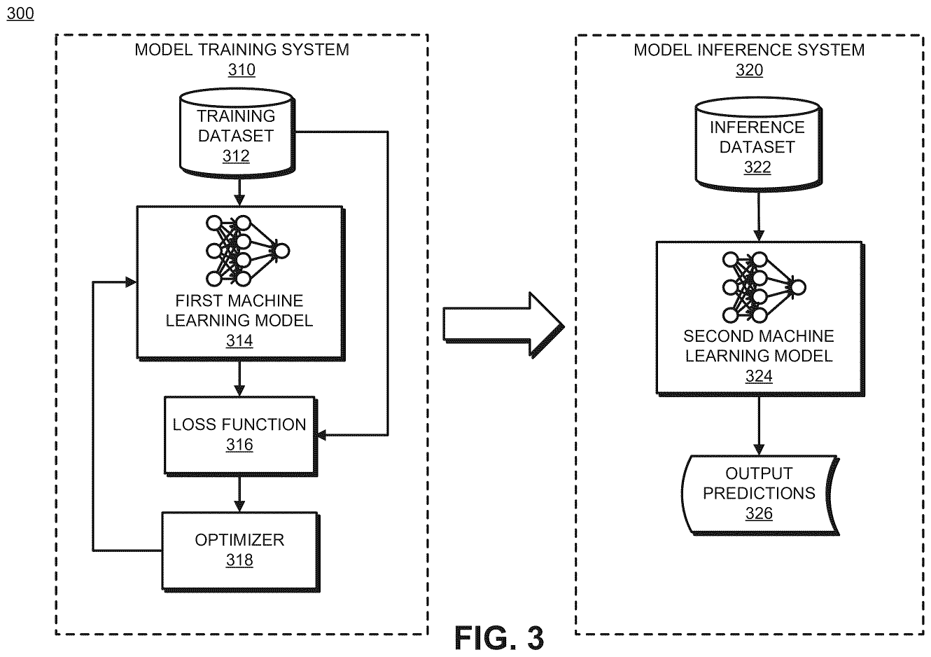

In at least one embodiment, storage 116 may refer to one or more hardware and software components described herein to store, retrieve, and manage data, allowing information to be saved and accessed by one or more entities (e.g., computer system 110, one or more processors 112, one or more hardware accelerators 114, item placement module 118, robot controller 120, sensor module 122, system 200 illustrated in FIG. 2, system 300 illustrated in FIG. 3). Storage 116 may include one or more of random access memory (RAM), read-only memory (ROM), flash memory (e.g., Universal Serial Bus (USB) flash drives, SSD, memory cards), cache memory, hard disk drives (HDDs), virtual memory, graphics memory, optical discs, network-attached storage (NAS), cloud storage, tape storage Additionally, the storage may further include one or more of relational databases, NoSQL databases, key-value stores, document-oriented databases, column-family stores, and graph databases. In addition, storage 116 may also include one or more of code repositories, artifact repositories, content repositories, document repositories, package repositories. Furthermore, storage 116 may include one or more of file storage (e.g., network-attached storage (NAS), cloud storage service), block storage, object storage, cache storage, tape storage, etc.

In some examples, storage 116 may store sensor data generated by sensors 142. Storage 116 may store modified sensor data (e.g., images with labels, augmented images) generated by item placement module 118. Storage 116 may store machine learning model training data (e.g., images with ground truth labels) to train the one or more machine learning models described herein. Storage 116 may hold distinct sets of criteria that item placement module 118 uses to evaluate object 144 during the processes of picking, scanning, and placing it within station 130. Storage 116 may retain the evaluation results after object 144 is placed into the second container 148. Storage 116 may record the destinations of various items, such as object 144, after they are placed into trays like the second container 148 at the station 130.

In at least one embodiment, item placement module 118 can refer to a module to use computer vision techniques to perform automatic scanning and examination of items. Item placement module 118 may use one or more machine learning models to perform various tasks. The one or more machine learning models described throughout FIGS. 1-8 (e.g., first machine learning model 220, second machine learning model 230, third machine learning model 240 illustrated in FIG. 2) may refer to computational model comprising interconnected nodes (neurons) configured to process input data, identify patterns, and generate outputs based on learned relationships between the data. The one or more machine learning models may include convolutional neural networks (CNNs), recurrent neural networks (RNNs), long short-term memory (LSTM) networks, generative adversarial networks (GANs), autoencoders, transformer networks (e.g., bidirectional encoder representations from transformers (BERT), generative pre-trained transformer (GPT), text-to-text transfer transformer (T5), vision transformers (ViT), XLNet, feedforward neural networks. The one or more neural networks may comprise one or more parameters (e.g., one or more weights, one or more biases).

In at least one embodiment, item placement module 118 may communicate with sensor module 122 to cause a first sensor of sensors 142 within a space corresponding to first area 132 of station 130 to generate one or more first images including object 144 that is to be moved from a first container located within second area 134 of station 130.

In at least one embodiment, item placement module 118 may use a first machine learning model (e.g., the first machine learning model 220 illustrated in FIG. 2) to identify identifiers (e.g., barcodes) on object 144 using a first set of images captured by sensors 142. For instance, the first machine learning model can process high-resolution images at 17 frames per second, enabling it to efficiently localize and decode the identifiers. The field of view of sensors 142 may serve as the area of interest, allowing the system to identify items without needing discrete scans. Specifically, as items like object 144 enter this area of interest, sensors 142 may generate the first set of images that capture the identifiers from multiple perspectives. The item placement module 118 configures the area of interest based on the field of view of sensors 142 and the dimensions (e.g., length, width, height, depth, volume, weight) of the first area 132, second area 134, and third area 136. The field of view may vary based on the coordinates of at least one of the sensors 142 used to capture the first set of images. In some cases, the area of interest can be created by combining multiple fields of view, such as overlapping regions from a subset of sensors 142.

In at least one embodiment, the area of interest can be virtual or based on markers within station 130. Item placement module 118 may project the three-dimensional area of interest onto two-dimensional images and indicate this to machine learning models (e.g., the first machine learning model 220). This enables the machine learning models to attend to the relevant portions of the input images when predicting the item being manipulated and/or identifying the item's structured identifier.

In at least one embodiment, item placement module 118 may use a second machine learning model (e.g., the second machine learning model 230 illustrated in FIG. 2) to ascertain whether an item is placed within second container 148. This second machine learning model may use a second set of images that include the object positioned above the third area 136. In some instances, sensors 142 may capture this second set of images. Alternatively, a subset of sensors 142, not used for capturing the first set of images, may capture the second set. Sensors 142 can either periodically capture the second set of images or do so upon receiving an indication that the item's identifier has been recognized. The second machine learning model can classify, using the second set of images, the state of the second container 148 as either empty or containing an item, such as object 144. This classification may allow item placement module 118 to direct the movement of the second container 148 (e.g., by activating one or more conveyor belts to move the second container 148) once the items are confidently identified.

In at least one embodiment, item placement module 118 may use a third machine learning model (e.g., third machine learning model 240 illustrated in FIG. 2) to execute a checklist (e.g., a set of criteria or requirements) for examining items. This checklist can be used to determine the destination of second container 148. The checklist can be an indication of a go/stop or valid/invalid. For instance, if object 144 is damaged (e.g., shampoo leaking), the second container 148 can be directed to one or more stations within the fulfillment center that handle damaged items. Similarly, if a size of object 144 exceeds a certain threshold, the second container 148 can also sent to the stations that handle bulky items. Item placement module 118 can use the third machine learning model to determine whether object 114 has a defect and generate status information based on this determination. Specifically, the third machine learning model can determine whether the item is valid or not for further processing (e.g., move to another station within the fulfillment center. Additionally, the third machine learning model can compare images (e.g., the first set of images, the second set of images) with previously captured images from other stations within the fulfillment center. This comparison allows item placement module 118 to identify items without relying on the first machine learning model, thereby streamlining the process.

In at least one embodiment, item placement module 118 may include system 200 illustrated in FIG. 2. In at least one embodiment, item placement module 118 may include an image processing module that generates and preprocesses (e.g., denoises, downsamples, upsamples, or otherwise modifies) images usable by the item placement module 118. The image processing module may receive one or more images or frames from sensor module 122 and modify those images or frames. Modifications may include, for example, resizing, cropping, normalization (e.g., scaling intensity values), augmentation (e.g., rotation, flipping, zooming, shifting, other affine transforms), redistribution of intensity values (e.g., histogram equalization), denoising, enhancement (e.g., increasing brightness, contrast, sharpness), color space conversion, filtering (e.g., Laplacian, Sobel, Gaussian blur), image alignment, scaling (e.g., deep learning super-sampling (DLSS), Xe super-sampling (XeSS), AMD FidelityFX Super Resolution (FSR)), and/or anti-aliasing (e.g., multi-sample anti-aliasing (MSAA), fast approximate anti-aliasing (FXAA), temporal anti-aliasing (TAA), super-sampling anti-aliasing (SSAA), conservative morphological anti-aliasing (CMAA)).

Additionally, the image processing module may generate or modify machine learning model training data that can be used by the image processing module. For example, the image processing module may generate labels for supervised learning or generate partially labeled data for semi-supervised learning of machine learning models. The image processing module may receive indications of ground truth to generate those labels. The image processing module may increase the number of channels of image data by adding time series information to the image data.

In at least one embodiment, sensor module 122 may refer to a module that controls the one or more sensors and one or more lighting elements described herein. The one or more sensors may refer to a device or component that detects, measures, and responds to physical, chemical, or environmental changes, such as temperature, pressure, motion, light, sound, or proximity, and converts this information into signals or data that can be interpreted by sensor module 122. The one or more sensors may may include cameras, color sensors, proximity sensors, distance sensors (e.g., Time of Flight sensor) LiDAR, etc.

In at least one embodiment, sensor module 122 may manage one or more sensors 142 to collect data, such as a series of images featuring object 144, captured in various areas (e.g., first area 132, third area 136) of station 130. One or more sensors 142 can offer multiple perspectives of object 144. In some cases, one or more sensors 142 can be positioned in fixed locations, particularly within a hood that covers parts of the third area 136 and the first area 132.

In at least one embodiment, the one or more lighting elements may refer to components such as light panels, LED lights, flashlights, or ring lights that are attached to the one or more sensors to provide additional illumination. The one or more lighting elements can enhance image quality by improving lighting in low-light conditions, reducing shadows, and ensuring the subject is well-lit for clearer, sharper photos or videos.

In at least one embodiment, station 130 may include one or more robots that may refer t an automated machine that handles, transports, or process object 144 without human intervention within a distribution center. The one or more robots may include EoAT which is a functional interface for interacting with object 144. EoAT may include vacuum grippers (e.g., Vacuum cups, foam vacuum grippers) which use suction to securely lift and place object 144. EoAT may include mechanical grippers (e.g., parallel grippers, angular grippers, three-finger grippers) which includes fingers or clamps to grasp object 144. EoAT may include magnetic or electrostatic grippers, which manipulate object 144 with conductive surface. EoAT may include force-torque sensors for adaptive gripping. EoAT may include soft grippers (e.g., silicone gripper, rubber gripper).

In at least one embodiment, robot controller 120 may refer to a module that directs the functions of various types of the one or more robots. Robot controller 120 may receive sensor data from various sensors described herein and processes this data to generate movement commands, manage obstacle avoidance, and adapt to dynamic conditions surrounding the one or more robots. The robot controller may include WiFi and Bluetooth for data exchange with the one or more robots or the plurality of sensors. Robot controller 120 robot controller 120 may work in conjunction with item placement module 118 and/or the sensor module 122 to ensure that the robots pick items, such as object 144, from a first container located in the second area 134. The robots then move the items along a path that passes through an area of interest positioned above the first area 132, and finally place the items into the second container 148.

In at least one embodiment, a container that includes object 144 may enter second area 134 of station 130, wherein second area 134 can be adjacent to first area 132 along a first edge. Entities such as associates, or robotic arms can pick object 144 and move it to first area 132, wherein first area 132 is adjacent to third area 136 along a second edge. In some examples, the first edge and second edge can be perpendicular to each other, forming an L-shaped arrangement with first area 132 being an intersection.

In at least one embodiment, as the entities move object 144 into first area 132, sensor module 122 controls a first camera of sensors 142 to generate one or more first images that include object 144 that enters the area of interest positioned above first area 132, wherein the area of interest is identified based, at least in part, on where the first camera is located with respect to station 130 and dimensions of first area 132.

In at least one embodiment, item placement module 118 may detect, using a first machine learning model (e.g., first machine learning model 220 illustrated in FIG. 2), a structured identifier (e.g., barcode) corresponding to object 1444 based, at least in part, on the one or more first images. The entities may move object 144 into third area 136. As object enters 144 third area, sensor module 122 may control a second camera of sensors 142 positioned above third area 136 to generate one or more second images comprising the object that is outside the area of interest.

In at least one embodiment, item placement module 118 may generate, using a second machine learning model (e.g., second machine learning model 230 illustrated in FIG. 2), an indication of whether the object is stored within second container 148 based, at least in part, on the one or more second images. Computer system 110 may cause container belts that crosses third area 136 and first area to move object 144 outside of station 130 (e.g., next station) based, at least in part, on the indication of whether the object is stored within second container 148 and information of the object 144 obtained from the structured identifier.

In some examples, the first area 132, second area 134, and third area 136 are not limited to rectangular shapes but can be of any other shapes (e.g., polygon, square, circle, triangle). Each area can have a different shape. One or more edges of the first area 132, second area 134, and third area 136 can be a straight line, a curved line, or a jagged line. Collectively, the first area 132, second area 134, and third area 136 may constitute a T-shaped or 90-degree counterclockwise L-shaped arrangement, causing object 144 to travel through the first area 132, second area 134, and third area 136 by changing direction perpendicularly. In various examples, the first area 132 and third area 136 can be positioned such that a line or conveyor belt can pass through both areas, and that line or conveyor belt can be crossed by one of the edges of second area 134 if it can be extended to first area 132. As a result, entities such as associates or robots can rotate their arms to move object 144 while minimizing the movement of their base. For example, an associate can keep their feet planted in the same position and rotate their torso to move an object from the second area to the first area. In this example, the associate does not need to walk or lift their feet to move an item, and the associate can rotate their torso a relatively small amount to move the item.

FIG. 2 illustrates system 200 to use machine learning models to generate status information of objects to move or otherwise manipulate objects, in accordance with at least one embodiment. System 200 may include sensors 210, first machine learning model 220, second machine learning model 230, and third machine learning model 240.

In at least one embodiment, sensors 210 may capture various images within a station (e.g., station 130 in FIG. 1, station 400 in FIG. 4) of a fulfillment center. These sensors are strategically positioned above different areas (e.g., first area 132, third area 136 in FIG. 1, first area 416, third area 420 in FIG. 4) to capture items at various stages of the process, such as pick up, scan, and place. In some cases, two or more of sensors 210, positioned at different coordinates, are used to capture images at each stage, offering a comprehensive view of the items. Alternatively, a single image may suffice. The images captured at different stages serve as inputs to machine learning models, including the first machine learning model 220, second machine learning model 230, and third machine learning model 240.

In at least one embodiment, first machine learning model 220 may refer to a machine learning model to identify item identifiers (e.g., object 144 in FIG. 1). First machine learning model 220 can detect regions within a set of images that contain structured identifiers on the items. Specifically, the set of images are captured when the item enters the area of interest that is determined based on one or more field or interests of sensors 210, dimensions of different areas of the station, and coordinates of sensors 210. First machine learning model may include a fully convolutional one-stage object detection architecture and may also incorporate other convolutional neural networks such as LeNet, AlexNet, Visual Geometry Group, Inception, ResNet, U-Net, DenseNet, MobileNet, EfficientNet, Capsule Networks, YOLO, V-Net, among others. Additionally, first machine learning model 220 may include feedforward neural networks, recurrent neural networks, long short-term memory networks, autoencoders, generative adversarial networks, transformers, among others. By analyzing images captured by sensors 210 positioned above areas like first area 132 in FIG. 1 and/or first area 416 in FIG. 4, the first machine learning model 220 can generate bounding boxes and confidence scores. These bounding boxes may indicate regions within the images that contain structural identifiers for the items. In some examples, first machine learning model 220 may predict the manipulated item within the image and generate a binary mask for it to identify the structural identifiers within the item.

In some examples, first machine learning model 220 may include a portion that generate indications to the set of images, where the indications are directed to the items. For example, the indications may include (1) label to each pixel that indicates what object or category the pixel belongs to; (2) binary masks that separate the target object from the background; (3) multi-class masks; and (4) boundary and edge maps. Alternatively, the portion is a separate neural network (e.g., convolutional neural network) that generates the indications.

In other examples, first machine learning model 220 may include a barcode decoder that may refer to a tool to decode one or more structured identifiers contained within the regions identified using other portions of first machine learning model 220. The barcode decoder can interpret the sequence of lines or patterns according to pre-set standards (such as UPC or QR codes). The barcode decoder can generate or obtain information related to the identified using the structured identifier that was within the items. The barcode decoder may include any kind of barcode scanning software. Information of one or more objects of interest may include, without limitation, product identification number, batch/lot number, expiration date, serial number, manufacturer information, price information, weight and dimensions, order information, destination data, among others.

In at least one embodiment, second machine learning model 230 may refer to a machine learning model to classify the state of a tray as either empty or containing an item. Second machine learning model 230 may analyze images captured at the station, where items are placed into trays. The input for second machine learning model 230 can be a single image, which is sufficient to determine the presence of an item within the tray. Additionally, second machine learning model 230 may include a verification mechanism using signaling device 250 as a backup. Signaling device 250 may refer to a system to generate information, warnings, alerts through visual, audible, or other sensory signals (e.g., infrared) to indicate a condition (e.g., whether entities passed a barrier or a region). In some examples, signaling device 250 may include light curtains, laser scanners, photoelectric sensors, ultrasonic sensors, infrared sensors, radar sensors, and RFID systems may be used. In other examples, vision systems, which combine cameras and machine learning models, may generate indications of whether a robotic arm or an associate has passed through an area, or a barrier configured by the vision system. If the model's confidence in its classification is low, signaling device 250 can send an indication whether the item is present or not. As a result, second machine learning model generates object placement data 232, which indicates whether the tray is empty or containing one or more items. This dual-layer approach ensures accuracy and reliability in the classification process.

In at least one embodiment, third machine learning model 240 may refer to a machine learning model to examine items, such as object 144 illustrated in FIG. 1. In one example, third machine learning model 240 may run a checklist (e.g., one or more conditions or factors) to examine items for potential issues such as damage or incorrect sizing. This checklist is informed by a lookup table that considers various factors, including the item's identifier and size, to determine if items needs to be routed differently. In other examples, third machine learning model 240 may compare current images of items with previous images captured within the fulfillment center. Running the checklist may include determining whether the item has a defect or not by performing a validation test or satisfaction of a criteria. This comparison may allow a system (e.g., computer system 110 illustrated in FIG. 1) to verify the identity of items without relying on the first machine learning model. By performing a one-to-one comparison between images taken at different points in the process, the third machine learning model 240 can confirm the item's identity and ensure it matches the stored image. The examination results 242, produced by the third machine learning model 240, may indicate whether the item passed any checklist criteria or if a matching identifier is found in previous images.

In at least one embodiment, first machine learning model 220, second machine learning model 230, and third machine learning model 240 can be combined into a single machine learning model to perform various tasks (e.g., identifying barcodes, determining whether the items are placed, determining whether the item complied with the checklist).

FIG. 3 illustrates a system to train and deploy machine learning models, according to at least one embodiment. System 300 may include a distributed system may refer to a network of independent computers that coordinate to achieve common functionality (e.g., machine learning model training, machine learning model inferencing). System 300 may include nodes connected via communication protocols, data distribution methods, and synchronization mechanisms. The nodes may execute processes concurrently across different machines, exchanging messages and replicating data. System 300 may perform load balancing and fault detection operate to manage resources and ensure system reliability. Alternatively, system 300 may include a single computer or a server that manages and controls all operations.

In at least one embodiment, system 300 may include model training system 310 and model inference system 320. Model training system 310 may refer to one or more of software and hardware described in conjunction with FIG. 1 to train one or more machine learning models described herein. Model training system 310 may include frameworks such as TensorFlow, PyTorch, Keras, MXNet, Caffe, Theano, etc. Model training system 310 may include using one or more hardware accelerators described herein (e.g., GPUs) to acclerator one or more portions to train one or more machine learning models such as, first machine learning model 314. First machine learning model 314 may include the one or more machine learning models described in conjunction with FIG. 1 and/or FIG. 2.

In at least one embodiment, model training system 310 may normalize and transform input data, such as training dataset 312. Model training system 310 may perform data normalization processes that scale feature values to a standard range, such as min-max scaling or z-score normalization. Model training system 310 may generate additional training samples to be added to training dataset 312 through transformations like rotation, flipping, or cropping. Model training system 310 may perform feature extraction operations, extracting relevant attributes from raw data, and feature selection, identifying the most significant features for first machine learning model 314. Model training system 310 may remove noise, address missing values, perform data cleaning tasks for training dataset 312.

In at least one embodiment, Model training system 310 define the layers and connections of first machine learning model 314. Model training system 310 may determine the type of each layer, such as convolutional, recurrent, or fully connected layers, and set parameters like the number of neurons or filters. Model training system 310 may assign specific activation functions, such as ReLU or sigmoid, to each layer to introduce non-linearity. Model training system 310 may establishes connection patterns by configuring how layers interact, including sequential arrangements, skip connections, or branching paths. Model training system 310 may define inputs and output layers to ensure appropriate data flow through first machine learning model 314. Model training system 310 initialize weights and biases for each connection, setting initial values that influence the training process. In some examples, initializing of weights and biases may include (1) Zero Initialization, which sets all weights to zero; (2) random Initialization, where weights are set to small random values; (3) Glorot Initialization that adjusts the scale of the weights according to the number of input and output neurons; and (4) He Initialization that sets weights with a variance scaled by the number of input neurons.

In at least one embodiment, first machine learning model 314 may refer to the one or more machine learning models described in conjunction with FIG. 1. In some examples, first machine learning model 314 may include an untrained machine learning model, which may refer to a machine learning model architecture that has been initialized but not yet exposed to any training data. In various examples, first machine learning model 314 may include pre-trained machine learning models, such as VGG, ResNet, GoogleNet, EfficientNEt, YOLO, BERT, GPT, T5, RoBERTa, XLNet, DeepSpeech, Wav2Vec, Jasper, AlphaZero, StyleGAN, etc. In other examples, first machine learning model 314 may include second machine learning model 324 that is already trained.

In at least one embodiment, training dataset 312 may refer to a collection of labeled or unlabeled data used to train first machine learning model 314. Training dataset 312 may include input samples, which represent the features or attributes that the machine learning model processes, and corresponding target outputs, which first machine learning model 314 aims to predict. Training dataset 312 may include batches or mini-batches. Training dataset 312 may include various data formats, such as images, text, or numerical data, by structuring the data in formats compatible with the input layer of first machine learning model 314. Additionally, training dataset 312 may include metadata that provides information about the data sources, labeling schemes, and any preprocessing steps applied, as noted above. In some examples, there can be one or more machine learning models (separate from first machine learning model 314) that generates training dataset 312. For example, the one or more machine learning models may include Generative Adversarial Networks (GANs) or Variational Autoencoders (VAEs) that mimic the characteristics of a genuine dataset. In other examples, one or more teacher machine learning models can generate predicted labels, intermediate feature representations, or synthetic samples to encapsulate learned patterns of the one or more teacher machine learning models. The generated information can be part of training dataset 312, which is used to train the first machine learning model 314, transforming it into a student machine learning model. In some examples, the one or more teacher machine learning models are trained using more viewpoints compared to those used to train first machine learning model 314.

In at least one embodiment, model training system 310 performs forward pass using training dataset 312. The forward pass may refer to a process where input data from training dataset 312 propagates through first machine learning model 314 to generate output predictions. The forward pass may include feeding input samples into the input layer of first machine learning model 314, sequentially passing data through each hidden layer of first machine learning model 314 by applying the defined activation functions, and producing outputs in the output layer of first machine learning model 314. Model training system 310 may process each layer's computations by performing matrix multiplications with weights, adding biases, and applying activation functions to introduce non-linearity.

In at least one embodiment, model training system 310 uses loss function 316 to evaluate discrepancy between the output predictions and actual target values from training dataset 312 generated during the forward pass. Loss function 316 may include mechanisms for calculating the difference using specific mathematical formulations, such as mean squared error for regression tasks or cross-entropy loss for classification tasks. Loss function 316 can include aggregations of individual errors across the training samples to produce a single scalar value representing the overall performance of first machine learning model 314.

In at least one embodiment, optimizer 318 may refer to a computational compoennt that adjusts weights and biases of first machine learning model 314 to minimize loss function 316. Optimizer 318 may include algorithms such as stochastic gradient descent (SGD), Adam, and RMSprop, each implementing specific strategies for updating parameters based on calculated gradients. Optimizer 318 may calculate gradients of loss function 316 with respect to each parameter by applying backpropagation, determining the direction and magnitude of adjustments needed. Optimizer 318 may manage learning rates, which control the step size of each update, and may incorporate techniques like momentum to accelerate convergence by considering past gradient information. Optimizer 318 may perform adaptive learning rate adjustments and allow different parameters to be updated at varying rates based on their individual gradient histories. Optimizer 318 may execute iterative update rules during each training epoch, systematically refining parameters of first machine learning model 314 to progressively reduce the loss and improve the performance of first machine learning model 314 on training dataset 312.

In at least one embodiment, model training system 310 may perform training in a supervised, partially supervised, or unsupervised manner. Model training system 310 may perform federated learning, where multiple decentralized devices or servers collaboratively train first machine learning model 314 while keeping the training data (e.g., portions of training dataset 312) localized.

In at least one embodiment, model training system 310 may perform fine tuning of of first machine learning model 314. Fine tuning may refer to performing additional training on a new, often more specific dataset to adapt its parameters for a particular task. Fine tuning may include loading the pre-trained weights and biases into the architecture of first machine learning model 314, selecting specific layers of first machine learning model 314 to update while freezing others to retain previously learned features. Fine tuning may include reinitializing certain layers of first machine learning model 314 if necessary and applying regularization techniques to prevent overfitting during the subsequent training phases. Fine tuning may include configuring a lower learning rate to make subtle adjustments to the parameters first machine learning model 314 of to ensure that the existing knowledge is preserved while accommodating new information.

In at least one embodiment, model training system 310 may perform the iterative process until first machine learning model 314 achieves a desired accuracy. For example, model training system 310 may evaluate first machine learning model 314 using a test or validation set and the accuracy can be the ratio of correctly predicted labels. In some examples, accuracy of first machine learning model 314 may depend on the final loss on the test or validation set. After determining that the desired accuracy is met, first machine learning model 314 becomes second machine learning model 324. In some examples, second machine learning model 324 may refer to one or more machine learning models described in conjunction with FIGS. 1 and 2.

In at least one embodiment, model inference system 320 may refer to a framework that executes trained machine learning models, such as second machine learning model 324 to generate output predictions 326 based on new input data, such as inference dataset 322. Model inference system 320 may load and initialize parameters (e.g., weights, biases) of second machine learning model 324 into the runtime environment. Model inference system 320 feeds inference dataset 322 to input layer of second machine learning model 324, where values are generated and propgated through one or more layers of second machine learning model 324 and output predictions 326 are generated. In some examples, inference dataset 322 may include images, videos, text, audio, etc. inference dataset 322 may include synthetic data generated by machine learning models (e.g., GAN) other than second machine learning model 324.

In at least one embodiment, model inference system 320 may include cloud servers or edge devices to deploy second machine learning model 324. Model inference system 320 may include cores, devices, inference chips, GPUs to generate activations to further generate output predictions 326. Output predictions 326 may include classification labels, proability distributions, continuous numerical values, sequences, images, translations, embeddings, actions, structued data outputs, audio, heatmaps, attention maps, generative content, etc.

FIG. 4 illustrates station 400 to move or otherwise manipulate an object using machine learning models, in accordance with at least one embodiment. Station 400 can be a station within a fulfillment center to optimize the process of item handling and scanning. Station 400 may include station 130 illustrated in FIG. 1.

In some examples, area breakdown 414 of station 400 may show several distinct areas or zones: first area 416, second area 418, third area 420, and entity 412. First area 416 may form an L-shaped arrangement by intersecting with the second area 418 and the third area 420, which are perpendicular to each other. The left edge of the first area 416 can be perpendicular to both the bottom and top edges of the third area 420. Similarly, the bottom edge of the first area 416 is perpendicular to both the left and right edges of the second area 418. Additionally, the left edge of the second area 418 can be perpendicular to the bottom edge of the third area 420. In other configurations, the first area 416 may be smaller than both the third area 420 and the second area 418. The first area 416 and the third area 420 are taller than the second area 418, with both having the same height.

In some examples, a conveyor belt passes through third area 420 and first area 416, and one of the edges of the second area 418 can be perpendicular to the conveyor belt. When the item leaves station 400, the item within the second container 406 is conveyed away from the third area 420 and the first area 416. In other examples, the areas illustrated by area breakdown 414 (e.g., first area 416, second area 418, third area 420) can be of different shapes (e.g., rectangular, square, circle, triangle, oval, polygons) or any other freeform shape, but as a whole, they constitute an exact or close to T-shaped or L-shaped arrangement. This allows entity 412 to move items through the area by only rotating its torso or arms without moving its base. In various examples, the structure of system 400 allows the items to move along an L-shaped path rotated 90 degrees counterclockwise or a T-shaped path with its left horizontal arm and vertical stem removed while passing through the second area 418, first area 416, and third area 420 for picking, scanning, and placing.

In at least one embodiment, first container 404 can be located in the second area 418 and may include totes. Display 410 and an area of interest 408 are positioned above the first area 416. The second container 406 is situated in the third area 420, which can also include a light curtain acting as a boundary between the third area 420 and the entity 412 operating at station 400. A hood covers portions of both third area 420 and first area 416, with one or more sensors 402 located beneath the hood.

In at least one embodiment, first container 404 may enter second area 418 from other stations or systems within a fulfillment center. This entry may occur in response to an order for one or more items contained within the first container 404. Entity 412, which may include associates, operators, or robotic systems such as EoAT or other robotic arms may pick these items from first container 404.

In some examples, to scan and place the items into second container 406, which may include trays, entity 412 may move its arm from the second area 418 to the third area 420. During this process, the items may pass through the second area 418, first area 416, and third area 420. The arm of entity 412 can move up to 90 degrees, with the center of the entity serving as a fixed axis. For example, if entity 412 is an associate or operator, they can rotate their torso up to 45 degrees without needing to move around station 400 while picking, scanning, and placing the items.

In some examples, machine learning models (e.g., first machine learning model 220 illustrated in FIG. 2) are used to automatically scan the items by executing one or more blocks of processes 500, 600, and 700, as illustrated in FIGS. 5-7. For instance, sensors 402 can capture images of the items as they travel from the first container 404 to the area of interest 408. Area of interest 408 can be determined based on the field of view of the sensors 402 and the dimensions of the first area 416, second area 418, and third area 420. The positioning of sensors 402 relative to the first area 416 can also be used to determine area of interest 408.

As the items pass through the area of interest, their identifiers can be scanned using the machine learning models described herein. When entity 412 places the items into the second container 406, sensors 402 or other sensors near the second container 406 can capture additional images to verify the placement of the items using the machine learning models. Additionally, the machine learning models can run a checklist to determine the destination of the second container 406 and to display the status of the items on display 410. Consequently, entity 412 can efficiently move its arm up to 90 degrees to pick, scan, and place the items for further processing.

In some examples, entity 412 can include one or more robotic arms. The movement of the robotic arms (e.g., degree of rotation) can be based on whether an item meets one or more criteria as a result of running one or more machine learning models (e.g., the third machine learning model 240). For instance, if the machine learning models indicate that the item has a defect (e.g., liquid damage), the robotic arms can rotate to a lesser or greater degree to place the item into a separate container or dedicated space for items with defects. In other examples, the robotic arms may rotate to a lesser or greater degree (or move more up or down) for more detailed scanning on the first area 416.

FIG. 5 illustrates process 500 performed by at least one processor to move or otherwise manipulate an object using machine learning models, according to at least one embodiment. Although process 500 is depicted as a series of steps or operations, it will be appreciated that at least one embodiment of process 500 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 500. For example, the one or more entities may include computer system 110, one or more processors 112, one or more hardware accelerators 114, storage 116, item placement module 118, robot controller 120, sensor module 122 illustrated in FIG. 1, first machine learning model 220, second machine learning model 230, third machine learning model 240 illustrated in FIG. 2, model training system 310, model inference system 320, and second machine learning model 324 illustrated in FIG. 3. The one or more entities may further include, for example, one or more of hardware and/or software described in conjunction with FIG. 1.

Various functions can be carried out by a processor executing instructions stored in memory (e.g., computer-readable, machine-readable) to perform process 500. For example, the instructions may include a computer program persistently stored on magnetic, optical, or flash media. Also, process 500 may be implemented as computer-usable instructions (e.g., macro instruction, micro-instruction) stored on computer storage media or provided by a standalone application, a service, or hosted service (standalone or in combination with another hosted service).

At block 502, the one or more entities may receive a first container (e.g., first container 404 illustrate in FIG. 4) including an object (e.g., object 144 illustrated in FIG. 1). In some examples, the first container can include multiple objects, such as different items or duplicate items. The one or more entities may use second rectangular area of a station (e.g., second area 134 illustrated in FIG. 1, second area 418 illustrated in FIG. 4) to receive the first container.

At block 504, the one or more entities may identify, using a first machine learning model (e.g., the first machine learning model 220 illustrated in FIG. 2), an identifier of the object based on one or more first images captured by one or more first sensors positioned above a first rectangular area of the station (e.g., first area 132 illustrated in FIG. 1, first area 416 illustrated in FIG. 4). The first machine learning model may include CNN and/or transformer neural networks to identify the location of the identifier and a barcode decoder to generate or obtain information about the object using the identifier.

At block 506, the one or more entities may determine, using a second machine learning model (e.g., the second machine learning model 230 illustrated in FIG. 2), whether the object is placed within a second container (e.g., second container 148 illustrated in FIG. 1, second container 406 illustrated in FIG. 4) based on one or more second images captured by one or more second sensors positioned above a third rectangular area of the station (e.g., third area 136 illustrated in FIG. 1, third area 420 illustrated in FIG. 4). The one or more images can be captured by the one or more first sensors. The second machine learning model can be a classifier. The second machine learning model may output two states: (1) the object is within the container, and (2) the object is not within the container. The second machine learning model may generate a confidence score that correspond to its prediction. In some examples, the second machine learning model may use indications from a light curtain (e.g., light curtain system 150 illustrated in FIG. 1) to determine whether the object is placed within the second container if the model generates a low confidence score. The second machine learning model can infer from one or more images, including the light curtain, that the arm used to move the object is clear.

At block 508, the one or more entities may cause a container belt, which crosses the third rectangular area and the first rectangular area, to move the second container outside of the station (e.g., next station or robots to process the second container) as a result of determining that the object is placed within it. In some examples, the destination of the second container (e.g., another station to process the object) can be based on information generated or obtained by an identifier. If there is a next object to process at block 510, process 500 may move to block 502. If there are no objects to process at block 510, process 500 may end. In some embodiments, one or more of the operations performed in blocks 502, 504, 506, 508, and 510 can be executed in various orders and combinations, including in parallel.

FIG. 6 illustrates process 600 performed by at least one processor to determine whether an object complies with a checklist using machine learning models, according to at least one embodiment. Although process 600 is depicted as a series of steps or operations, it will be appreciated that at least one embodiment of process 600 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 600. For example, the one or more entities may include computer system 110, one or more processors 112, one or more hardware accelerators 114, storage 116, item placement module 118, robot controller 120, sensor module 122 illustrated in FIG. 1, first machine learning model 220, second machine learning model 230, third machine learning model 240 illustrated in FIG. 2, model training system 310, model inference system 320, and second machine learning model 324 illustrated in FIG. 3. The one or more entities may further include, for example, one or more of hardware and/or software described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 600 may be implemented as computer-usable instructions (e.g., macro instruction, micro-instruction) stored on computer storage media or provided by a standalone application, a service, or hosted service (standalone or in combination with another hosted service).

At block 602, the one or more entities may receive a first container (e.g., first container 404 illustrate in FIG. 4) including an object (e.g., object 144 illustrated in FIG. 1). In some examples, the first container can include multiple objects, such as different items or duplicate items. The one or more entities may use second rectangular area of a station (e.g., second area 134 illustrated in FIG. 1, second area 418 illustrated in FIG. 4) to receive the first container.

At block 604, the one or more entities may identify, using a first machine learning model (e.g., the first machine learning model 220 illustrated in FIG. 2), an identifier of the object based on one or more first images captured by one or more first sensors positioned above a first rectangular area of the station (e.g., first area 132 illustrated in FIG. 1, first area 416 illustrated in FIG. 4). The first machine learning model may include CNN and/or transformer neural networks to identify the location of the identifier and a barcode decoder to generate or obtain information about the object using the identifier.

At block 606, the one or more entities may determine, using a second machine learning model (e.g., the second machine learning model 230 illustrated in FIG. 2), whether the object is placed within a second container (e.g., second container 148 illustrated in FIG. 1, second container 406 illustrated in FIG. 4) based on one or more second images captured by one or more second sensors positioned above a third rectangular area of the station (e.g., third area 136 illustrated in FIG. 1, third area 420 illustrated in FIG. 4). The one or more images can be captured by the one or more first sensors. The second machine learning model can be a classifier. The second machine learning model may output two states: (1) the object is within the container, and (2) the object is not within the container. The second machine learning model may generate a confidence score that correspond to its prediction. If the confidence score is low (e.g., lower than a threshold) at block 608, process 600 may move to block 610. If the confidence score is the same or above the threshold, process 600 may move to block 612.

At block 610, the one or more may entities cause second machine learning model to use indications from one or more signaling devices (e.g., light curtain system 150 illustrated in FIG. 1, signaling device 250 illustrated in FIG. 2) to determine whether the object is placed within the second container if the model generates a low confidence score. The second machine learning model can infer from one or more images, including the light curtain, that the arm used to move the object is clear.

At block 612, the one or more entities may determine, using a third machine learning model (e.g., third machine learning model 240 illustrated in FIG. 2) whether the object met the set of criteria. In some examples, the set of criteria may include, without limitation, whether the object was damaged (e.g., leaking shampoo), the size of the object (e.g., in relation to the size of the second container), the type of object (e.g., whether it is fragile), whether the object is similar to other objects, whether the object is for expedited processing, and whether the object needs special treatment. Additional criteria may include destination requirements, temperature sensitivity, regulatory compliance, weight limitations, hazardous material classification, ownership or custody transfer, customs clearance, insurance coverage, security requirements, and batch or lot number tracking.

At block 610, the one or more entities may cause a container belt, which crosses the third rectangular area and the first rectangular area, to move the second container outside of the station (e.g., move to a next station) as a result of determining that the object is placed within it. The third machine learning model may use a look up table determine where the object should be headed for further distribution, ensuring it is handled appropriately and reaches its intended destination efficiently. If there is a next object to process at block 612, process 600 may move to block 602. If there are no objects to process at block 612, process 600 may end. In some embodiments, one or more of the operations performed in blocks 602, 604, 606, 608, 610, and 612 can be executed in various orders and combinations, including in parallel.

FIG. 7 illustrates process 700 performed by a processor to determine whether an object complies with a checklist using machine learning models, according to at least one embodiment. Although process 700 is depicted as a series of steps or operations, it will be appreciated that at least one embodiment of process 700 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 700. For example, the one or more entities may include computer system 110, one or more processors 112, one or more hardware accelerators 114, storage 116, item placement module 118, robot controller 120, sensor module 122 illustrated in FIG. 1, first machine learning model 220, second machine learning model 230, third machine learning model 240 illustrated in FIG. 2, model training system 310, model inference system 320, and second machine learning model 324 illustrated in FIG. 3. The one or more entities may further include, for example, one or more of hardware and/or software described in conjunction with FIG. 1.

Various functions can be carried out by a processor executing instructions stored in memory (e.g., computer-readable, machine-readable) to perform process 700. For example, the instructions may include a computer program persistently stored on magnetic, optical, or flash media. Also, process 700 may be implemented as computer-usable instructions (e.g., macro instruction, micro-instruction) stored on computer storage media or provided by a standalone application, a service, or hosted service (standalone or in combination with another hosted service).

At block 702, the one or more entities may receive a first container (e.g., first container 404 illustrated in FIG. 4) including an object (e.g., object 144 illustrated in FIG. 1). In some examples, the first container can include multiple objects (e.g., items of different type, same but multiple items). The one or more entities may receive the first container through a second rectangular area of a station (e.g., second area 134 illustrated in FIG. 1, second area 418 illustrated in FIG. 4).

At block 704, the one or more entities may determine, using a first machine learning model (e.g., third machine learning model 240 illustrated in FIG. 3), whether the object matches a previously captured image of the same object. In some examples, various systems or stations within a fulfillment center previously generated one or more images the object as the object entered the center for further processing. The first machine learning model may compare previously captured images with one or more first images captured by one or more first sensors positioned above a first rectangular area of the station (e.g., first area 132 illustrated in FIG. 1, first area 416 illustrated in FIG. 4) to determine whether the object matches. If the object matches at block 706, process 700 may move to block 710 because the station can use identifiers from the previously captured images to generate information about the object. If the object does not match any previously taken images, process 700 may move to block 708 to identify the identifier.

At block 708, the one or more entities may identify, using a second machine learning model (e.g., the first machine learning model 220 illustrated in FIG. 2), an identifier of the object based on one or more first images captured by the one or more first sensors. The first machine learning model may include CNN and/or transformer neural networks to identify the location of the identifier and a barcode decoder to generate or obtain information about the object using the identifier.

At block 710, the one or more entities may may determine, using a third machine learning model (e.g., the second machine learning model 230 illustrated in FIG. 2), whether the object is placed within a second container (e.g., second container 148 illustrated in FIG. 1, second container 406 illustrated in FIG. 4) based on one or more second images captured by one or more second sensors positioned above a third rectangular area of the station (e.g., third area. The second machine learning model can be a classifier. The third machine learning model may output two states: (1) the object is within the container, and (2) the object is not within the container. The third machine learning model may generate a confidence score that correspond to its prediction. In some examples, the third machine learning model may use indications from a light curtain (e.g., light curtain system 150 illustrated in FIG. 1) to determine whether the object is placed within the second container if the model generates a low confidence score. The third machine learning model can infer from one or more images, including the light curtain, that the arm used to move the object is clear.

At block 712, the one or more entities may cause a container belt, which crosses the third rectangular area and the first rectangular area, to move the second container as a result of determining that the object is placed within it. In some examples, the destination of the second container (e.g., another station to process the object) can be based on information generated or obtained by an identifier. If there is a next object to process at block 714, process 700 may move to block 702. If there are no objects to process at block 710, process 700 may end. In some embodiments, one or more of the operations performed in blocks 702, 704, 706, 708, 710, 712 and 714 may be performed in various orders and combinations, including in parallel.

Any system or apparatus feature described herein may also be provided as a method feature, and vice versa. System and/or apparatus aspects described functionally (including means-plus-function features) may be expressed alternatively in terms of their corresponding structure, such as a suitably programmed processor and associated memory. It should also be appreciated that particular combinations of the various features described and defined in any aspect of the present disclosure can be implemented, supplied, and used independently.

Any system or apparatus feature described herein can include computer programs and computer program products comprising software code adapted, when executed on a data processing apparatus, to perform any of the methods and/or embody any of the apparatus and system features described herein, including any or all of the component steps of any method. Any system or apparatus feature described herein can also include a computer or computing system (including networked or distributed systems) having an operating system that supports a computer program for carrying out any of the methods described herein and/or embodying any of the apparatus or system features described herein. Any system or apparatus feature described herein can also include computer-readable media having stored thereon any one or more of the computer programs aforesaid. Any system or apparatus feature described herein can include a signal carrying any one or more of the computer programs aforesaid.

Note that, in the context of describing disclosed embodiments, unless otherwise specified, the use of expressions regarding executable instructions (also referred to as code, applications, agents) performing operations that “instructions” do not ordinarily perform unaided (e.g., transmission of data, calculations) denotes that the instructions are being executed by a machine, thereby causing the machine to perform the specified operations.

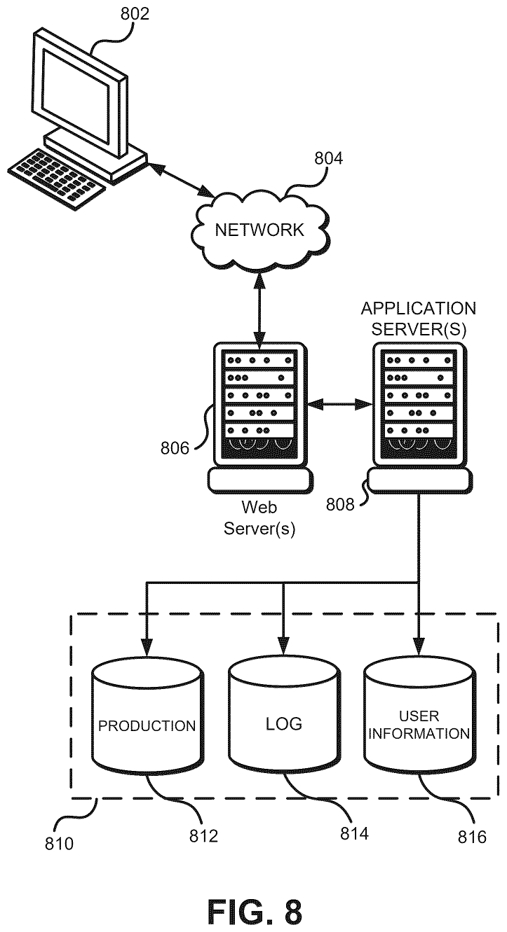

FIG. 8 illustrates aspects of an example system 800 for implementing aspects in accordance with an embodiment. As will be appreciated, although a web-based system is used for purposes of explanation, different systems may be used, as appropriate, to implement various embodiments. In an embodiment, the system includes an electronic client device 802, which includes any appropriate device operable to send and/or receive requests, messages, or information over an appropriate network 804 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 806 for receiving requests and serving content in response thereto, although for other networks an alternative device serving a similar purpose could be used as would be apparent to one of ordinary skill in the art.

In an embodiment, the illustrative system includes at least one application server 808 and a data store 810, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 802 and the application server 808, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 810, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 812 and user information 816, which are used to serve content for the production side. The data store also is shown to include a mechanism for storing log data 814, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 810.

The data store 810, in an embodiment, is operable, through logic associated therewith, to receive instructions from the application server 808 and obtain, update or otherwise process data in response thereto, and the application server 808 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 802. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 800 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 800, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 8. Thus, the depiction of the system 800 in FIG. 8 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C #or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

At least one embodiment of the disclosure can be described in view of the following clauses:
1. A station comprising:
   a first rectangular area, a second rectangular area, and a third rectangular area, wherein the second rectangular area is adjacent to the first rectangular area along a first edge, the third rectangular area is adjacent to the first rectangular area along a second edge, the second edge being perpendicular to the first edge, forming an L-shaped arrangement with the first rectangular area;
   one or more processors; and
   one or more non-transitory computer-readable media storing thereon executable instructions that, as a result of being executed by one or more processors of a computer system, cause the station to at least:
      use a first camera to generate one or more first images that include an object that enters an area of interest positioned above the first rectangular area from a first container located within the second rectangular area, wherein the area of interest is determined based, at least in part, on a placement of the first camera and dimensions of the
      detect, using a first machine learning model, an identifier corresponding to the object based, at least in part, on the one or more first images;
      use a second camera positioned above the third rectangular area to generate one or more second images comprising the object that is outside the area of interest;
      generate, using a second machine learning model, an indication of whether the object is stored within a second container based, at least in part, on the one or more second images; and
      cause the second container to move to a destination outside of the station based, at least in part, on the indication of whether the object is stored within the second container and information of the object obtained from the identifier.
2. The station of clause 1, wherein the executable instructions to cause the second container to move to a destination further comprises executable instructions that, as a result of being executed by one or more processors of a computer system, cause the station to at least:
   buse a third machine learning model to determine whether the object that is stored within the second container complied with a checklist based, at least in part, on the one or more second images, wherein the determination on whether object that is stored within the second container complied with a checklist is to further determine the destination of the second container.
3. The station of clause 1 or 2, further comprising a light curtain used to generate the indication of whether the object is stored within the second container when second machine learning model generates a confidence score below a threshold.
4. The station of any of clauses 1-3, wherein the area of interest comprises a three-dimensional (3D) polygon that comprises at least a portion of a path to that starts from the second rectangular area to pick up the object within the first container and ends at the third rectangular area to place the object to the second container.
5. A system comprising:
   a first area, a second area, and a third area, wherein the second area is adjacent to the first area along a first edge, the third area is adjacent to the first area along a second edge, and the second edge being perpendicular to the first edge;
   one or more processors; and
   memory that stores computer-executable instructions that, if executed by the one or more processors, cause the system to:
      obtain a first set of images that includes an object located within a region positioned corresponding to the first area, wherein the region is to be determined based, at least in part, on a field of view of a first sensor that generated the first set of images;
      identify, using a first machine learning model, an identifier associated with the object based, at least in part, on the first set of images;
      obtain a second set of images that includes the object to be placed in a first container located in the third area; and
      generate, using a second machine learning model, an indication of whether the object is placed inside the first container based, at least in part, on the second set of images.
6. The system of clause 5, wherein the computer-executable instructions further comprise computer-executable instructions that, if executed by the one or more processors, cause the system to:
   obtain a third set of images that includes a set of objects that was captured outside of the system;
   determine, using a third machine learning model, whether an additional object within the region matches with at least one of the set of objects;
   determine, using the second machine learning model, that the additional object is placed inside a second container located in the third area; and
   cause the second container to be transferred to a destination external to the system, based at least in part on the determination of whether the additional object within the region matches with at least one of the set of object.
7. The system of clause 5 or 6, wherein the computer-executable instructions further comprise computer-executable instructions that, if executed by the one or more processors, cause the system to:
   cause an end of arm tool (EoAT) to move the object from the second area to the third area to move the object to the first container, wherein a path of the EoAT comprises at least a portion of the region.
8. The system of any of clauses 5-7, wherein a container belt is positioned across the first and third areas to transport the first container out of the system, with at least one additional sensor positioned to provide another viewpoint comprising the first container and at least a portion of the container belt.
9. The system of any of clauses 5-8, wherein the computer-executable instructions to generate, using a second machine learning model, the indication further comprise computer-executable instructions that, if executed by the one or more processors, cause the system to use a signal from a signaling device to generate the indication of whether the object is stored within the first container when second machine learning model generates a confidence score below a threshold.
10. The system of any of clauses 5-9, wherein the computer-executable instructions further comprise computer-executable instructions that, if executed by the one or more processors, cause the system to:
   use a third machine learning model to determine whether a placement of the object within the first container met a plurality of criteria, wherein the plurality of criteria comprise determining whether a size of the object is below or above a threshold.
11. The system of any of clauses 5-10, wherein the computer-executable instructions further comprise computer-executable instructions that, if executed by the one or more processors, cause the system to:
   select a destination of a set of destinations for the object based, at least in part, on whether the placement of the object within the first container met a plurality of criteria within a checklist.
12. The system of any of clauses 5-11, wherein:
   a robotic arm comprises one or more end of arm tools (EoAT) to move an object between the first area, second area, and third area; and
   the robotic arm is configured to rotate to transfer the object between the second area and the third area, wherein a degree of the rotation is based, at least in part, on whether the object met one or more criteria.
13. A computer-implemented method, comprising:
   causing a first sensor within a space corresponding to a first area of a station to generate one or more first images including an object that is to be moved from a first container located within a second area of the station, wherein the second area borders the first area along a first edge, a third area borders the first area along a second edge, and the second edge being positioned perpendicularly to the first edge.
   using a first set of machine learning models to identify an identifier of the object based, at least in part, on the one or more first images;
   causing a second sensor within another space corresponding to the third area to generate one or more second images including an object that is to be placed within a second container located within the third area;
   using a second set of machine learning models to determine whether the object is placed within the second container based, at least in part, on the one or more second images; and
   causing the second container to be moved to a destination outside of the station as a result of the determination on whether the object is placed within the second container.
14. The computer-implemented method of clause 13, further comprising:
   generating an area of interest to generate the one or more first images based, at least in part, on a point of view of a first sensor used to generate the one or more first images and dimensions of the first area.
15. The computer-implemented method of clause 14, a robotic arm is configured to rotate to transfer to object between the second area and the third area, wherein the robotic arm comprises a plurality of suction cups usable to grab the object.
16. The computer-implemented method of any of clauses 13-15, further comprising:
   using a third machine learning model to determine whether a placement of the object within the second container met a plurality of criteria based, at least in part, on the one or more second images, wherein the plurality of criteria comprises determining whether the object has been damaged.
17. The computer-implemented method of any of clauses 13-16, wherein the determination of whether the object is placed within a second container is further based, at least in part, on an indication from a software program performed by a processor to receive information from a signaling device.
18. The computer-implemented method of any of clauses 13-17, further comprising:
   causing a display that is positioned above the first area to indicate information associated with the object generated based, at least in part, on the identifier of the object.
19. The computer-implemented method of any of clauses 13-18, wherein the first set of machine learning models comprises:
   a machine learning model to identify a location of the identifier within the one or more first images; and
   a barcode decoder to generate information of the object based, at least in part, on the location of the identifier.
20. The computer-implemented method of any of clauses 14-19, wherein the area of interest is a three-dimensional (3D) polygon positioned above the first area.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A station comprising:
a first rectangular area, a second rectangular area, and a third rectangular area, wherein the second rectangular area is adjacent to the first rectangular area along a first edge, the third rectangular area is adjacent to the first rectangular area along a second edge, the second edge being perpendicular to the first edge, forming an L-shaped arrangement with the first rectangular area;
one or more processors; and
one or more non-transitory computer-readable media storing thereon executable instructions that, as a result of being executed by one or more processors of a computer system, cause the station to at least:
use a first camera to generate one or more first images that include an object that enters an area of interest positioned above the first rectangular area from a first container located within the second rectangular area, wherein the area of interest is determined based, at least in part, on a placement of the first camera and dimensions of the first rectangular area;
detect, using a first machine learning model, an identifier corresponding to the object based, at least in part, on the one or more first images;
use a second camera positioned above the third rectangular area to generate one or more second images comprising the object that is outside the area of interest;
generate, using a second machine learning model, an indication of whether the object is stored within a second container based, at least in part, on the one or more second images; and
cause the second container to move to a destination outside of the station based, at least in part, on the indication of whether the object is stored within the second container and information of the object obtained from the identifier.

2. The station of claim 1, wherein the executable instructions to cause the second container to move to a destination further comprises executable instructions that, as a result of being executed by one or more processors of a computer system, cause the station to at least:
use a third machine learning model to determine whether the object that is stored within the second container complied with a checklist based, at least in part, on the one or more second images, wherein the determination on whether object that is stored within the second container complied with a checklist is to further determine the destination of the second container.

3. The station of claim 1, further comprising a light curtain used to generate the indication of whether the object is stored within the second container when second machine learning model generates a confidence score below a threshold.

4. The station of claim 1, wherein the area of interest comprises a three-dimensional (3D) polygon that comprises at least a portion of a path to that starts from the second rectangular area to pick up the object within the first container and ends at the third rectangular area to place the object to the second container.

5. A system comprising:
a first area, a second area, and a third area, wherein the second area is adjacent to the first area along a first edge, the third area is adjacent to the first area along a second edge, and the second edge being perpendicular to the first edge;
one or more processors; and
memory that stores computer-executable instructions that, if executed by the one or more processors, cause the system to:
obtain a first set of images that includes an object located within a region positioned corresponding to the first area, wherein the region is to be determined based, at least in part, on a field of view of a first sensor that generated the first set of images;
identify, using a first machine learning model, an identifier associated with the object based, at least in part, on the first set of images;
obtain a second set of images that includes the object to be placed in a first container located in the third area; and
generate, using a second machine learning model, an indication of whether the object is placed inside the first container based, at least in part, on the second set of images.

6. The system of claim 5, wherein the computer-executable instructions further comprise computer-executable instructions that, if executed by the one or more processors, cause the system to:
obtain a third set of images that includes a set of objects that was captured outside of the system;
determine, using a third machine learning model, whether an additional object within the region matches with at least one of the set of objects;
determine, using the second machine learning model, that the additional object is placed inside a second container located in the third area; and
cause the second container to be transferred to a destination external to the system, based at least in part on the determination of whether the additional object within the region matches with at least one of the set of object.

7. The system of claim 5, wherein the computer-executable instructions further comprise computer-executable instructions that, if executed by the one or more processors, cause the system to:
cause an end of arm tool (EoAT) to move the object from the second area to the third area to move the object to the first container, wherein a path of the EoAT comprises at least a portion of the region.

8. The system of claim 5, wherein a container belt is positioned across the first and third areas to transport the first container out of the system, with at least one additional sensor positioned to provide another viewpoint comprising the first container and at least a portion of the container belt.

9. The system of claim 5, wherein the computer-executable instructions to generate, using a second machine learning model, the indication further comprise computer-executable instructions that, if executed by the one or more processors, cause the system to use a signal from a signaling device to generate the indication of whether the object is stored within the first container when second machine learning model generates a confidence score below a threshold.

10. The system of claim 5, wherein the computer-executable instructions further comprise computer-executable instructions that, if executed by the one or more processors, cause the system to:
use a third machine learning model to determine whether a placement of the object within the first container met a plurality of criteria, wherein the plurality of criteria comprise determining whether a size of the object is below or above a threshold.

11. The system of claim 10, wherein the computer-executable instructions further comprise computer-executable instructions that, if executed by the one or more processors, cause the system to:
select a destination of a set of destinations for the object based, at least in part, on whether the placement of the object within the first container met a plurality of criteria within a checklist.

12. The system of claim 5, wherein:
a robotic arm comprises one or more end of arm tools (EoAT) to move an object between the first area, second area, and third area; and
the robotic arm is configured to rotate to transfer the object between the second area and the third area, wherein a degree of the rotation is based, at least in part, on whether the object met one or more criteria.

13. A computer-implemented method, comprising:
causing a first sensor within a space corresponding to a first area of a station to generate one or more first images including an object that is to be moved from a first container located within a second area of the station, wherein the second area borders the first area along a first edge, a third area borders the first area along a second edge, and the second edge being positioned perpendicularly to the first edge.
using a first set of machine learning models to identify an identifier of the object based, at least in part, on the one or more first images;
causing a second sensor within another space corresponding to the third area to generate one or more second images including an object that is to be placed within a second container located within the third area;
using a second set of machine learning models to determine whether the object is placed within the second container based, at least in part, on the one or more second images; and
causing the second container to be moved to a destination outside of the station as a result of the determination on whether the object is placed within the second container.

14. The computer-implemented method of claim 13, further comprising:
generating an area of interest to generate the one or more first images based, at least in part, on a point of view of a first sensor used to generate the one or more first images and dimensions of the first area.

15. The computer-implemented method of claim 14, a robotic arm is configured to rotate to transfer to object between the second area and the third area, wherein the robotic arm comprises a plurality of suction cups usable to grab the object.

16. The computer-implemented method of claim 13, further comprising:
using a third machine learning model to determine whether a placement of the object within the second container met a plurality of criteria based, at least in part, on the one or more second images, wherein the plurality of criteria comprises determining whether the object has been damaged.

17. The computer-implemented method of claim 13, wherein the determination of whether the object is placed within a second container is further based, at least in part, on an indication from a software program performed by a processor to receive information from a signaling device.

18. The computer-implemented method of claim 13, further comprising:
causing a display that is positioned above the first area to indicate information associated with the object generated based, at least in part, on the identifier of the object.

19. The computer-implemented method of claim 13, wherein the first set of machine learning models comprises:
a machine learning model to identify a location of the identifier within the one or more first images; and
a barcode decoder to generate information of the object based, at least in part, on the location of the identifier.

20. The computer-implemented method of claim 14, wherein the area of interest is a three-dimensional (3D) polygon positioned above the first area.
